(19) United States
(12) Patent Application Publication
(10) Pub. No.: US 2025/0048216 A1
(43) Pub. Date: Feb. 6, 2025

(54) APPARATUSES, METHODS AND COMPUTER PROGRAMS FOR EXCHANGING IMPACT INFORMATION

(71) Applicant: Nokia Technologies Oy, Espoo (FI)

(72) Inventors: Anna PANTELIDOU, Massy (FR); Ethiraj ALWAR, Bangalore (IN)

(21) Appl. No.: 18/762,175

(22) Filed: Jul. 2, 2024

(30) Foreign Application Priority Data
Aug. 1, 2023 (FI) 20235858

(51) Int. Cl. H04W 36/22; H04W 24/08

(52) U.S. Cl. CPC H04W 36/22; H04W 24/08

(57) ABSTRACT

According to various, but not necessarily all, examples there is provided an apparatus for a network node, the apparatus comprising: means for sending a message to a target network node, the message comprising a request for measurement information of a measurement on an energy cost of the target network node, and the message comprising a message field requesting impact information of an impact of at least one other network node on the measurement; means for receiving from the target network node the measurement information and the impact information; and means for performing, based on the measurement information and the impact information, at least one action related to traffic offloading.

### TECHNOLOGICAL FIELD

Examples of the disclosure relate to apparatuses, methods and computer programs for exchanging impact information. Some relate to apparatuses, methods and computer programs for exchanging impact information of the impact of a network node on the measurement of energy cost of another network node.

### BACKGROUND

In cellular networks, measurements of node level and cell level metrics may be performed, and information about these measurements may be exchanged between network nodes. One such metric is energy cost.

It can be useful to determine the energy cost of a network node in response to traffic offloading, from another network node to the network node, in order to optimise the network. The traffic offloading may involve one or more handovers, such as handovers of user equipment.

### BRIEF SUMMARY

According to various, but not necessarily all, examples there is provided an apparatus for a network node, the apparatus comprising: means for sending a message to a target network node, the message comprising a request for measurement information of a measurement on an energy cost of the target network node, and the message comprising a message field requesting impact information of an impact of at least one other network node on the measurement; means for receiving from the target network node the measurement information and the impact information; and means for performing, based on the measurement information and the impact information, at least one action related to traffic offloading.

The network node may be a node in a radio access network. The measurement on the energy cost may relates to at least one handover from the network node to the target network node.

The impact may be the impact on the measurement of at least one traffic offloading action between the target network node and the at least one other network node.

The impact information may comprise an impact level. The impact level may be the energy cost due to the impact of the at least one other network node on the measurement. The impact information may comprise an impact indicator which indicates whether the impact level includes any impact from ongoing offloading traffic. The impact information may comprise a duration of the impact.

The message may further comprise configuration information, wherein the configuration information is for configuring sending the measurement information and the impact information from the target network node. The configuration information may comprise instructions to send the impact information in response to: an offloading action between the target network node and at least one other network node; the impact level exceeding a threshold; and/or a ratio of the impact level to the energy cost exceeding a threshold. The configuration information may comprise instructions to send the impact information substantially immediately after the impact information is acquired and/or to send the impact information concurrent with the measurement information.

The apparatus may further comprise: means for sending a further message to the target network node, the further message comprising an indication that the offloading traffic is complete. The configuration information may comprise instructions to send the impact information in response to the target network node receiving the indication that the offloading traffic is complete.

According to various, but not necessarily all, examples there is provided an apparatus for a network node, the apparatus comprising: means for receiving a message from a requesting network node, the message comprising a request for measurement information of a measurement on an energy cost of the network node, and the message comprising a message field requesting impact information of an impact of at least one other network node on the measurement; means for acquiring the measurement information; means for acquiring the impact information; means for sending to the requesting network node the measurement information and the impact information; and means for performing, based on the sent measurement information and the sent impact information, at least one action related to traffic offloading.

According to various, but not necessarily all, examples there is provided a method comprising: sending, by a requesting network node, a message to a target network node, the message comprising a request for measurement information of a measurement on an energy cost of the target network node, and the message comprising a message field requesting impact information of an impact of at least one other network node on the measurement; receiving, by the requesting network node, from the target network node the measurement information and the impact information; and performing, by the requesting network node and based on the measurement information and the impact information, at least one action related to traffic offloading.

According to various, but not necessarily all, examples there is provided a computer program comprising program instructions for causing a network node to perform at least the following: sending a message to a target network node, the message comprising a request for measurement information of a measurement on an energy cost of the target network node, and the message comprising a message field requesting impact information of an impact of at least one other network node on the measurement; receiving, from the target network node the measurement information and the impact information; and performing, based on the measurement information and the impact information, at least one action related to traffic offloading.

According to various, but not necessarily all, examples there is provided a method comprising: receiving, by a target network node, a message from a requesting network node, the message comprising a request for measurement information of a measurement on an energy cost of the target network node, and the message comprising a message field requesting impact information of an impact of at least one other network node on the measurement; acquiring, by the target network node, the measurement information; acquiring, by the target network node, the impact information; sending, by the target network node, to the requesting network node the measurement information and the impact information; and performing, by the target network node and based on the sent measurement information and the sent impact information, at least one action related to traffic offloading.

According to various, but not necessarily all, examples there is provided a computer program comprising program instructions for causing a network node to perform at least the following: receiving a message from a requesting network node, the message comprising a request for measurement information of a measurement on an energy cost of the target network node, and the message comprising a message field requesting impact information of an impact of at least one other network node on the measurement; acquiring the measurement information; acquiring the impact information; sending to the requesting network node the measurement information and the impact information; and performing, and based on the sent measurement information and the sent impact information, at least one action related to traffic offloading.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

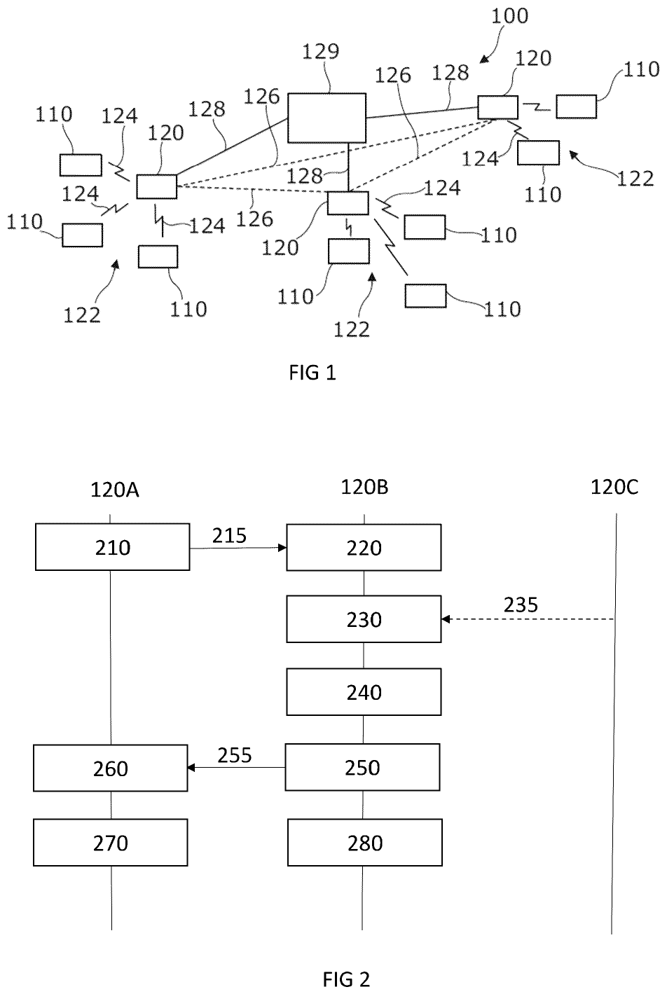

FIG. 1 shows an example embodiment of a communication system;

FIG. 2 shows an example embodiment of a signaling diagram for providing impact information;

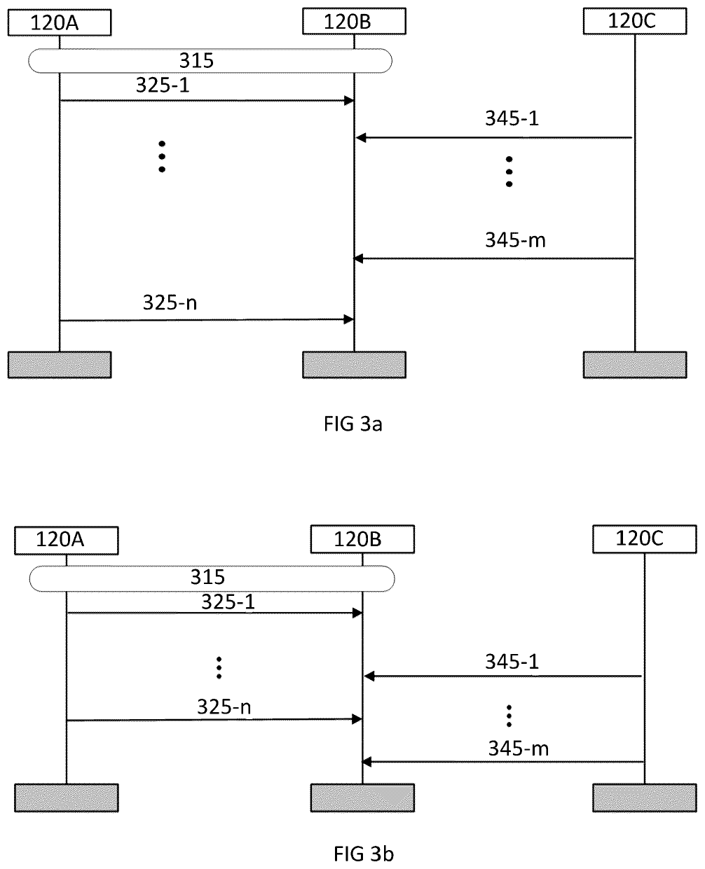

FIGS. 3a and 3b show further example embodiments of signaling diagrams;

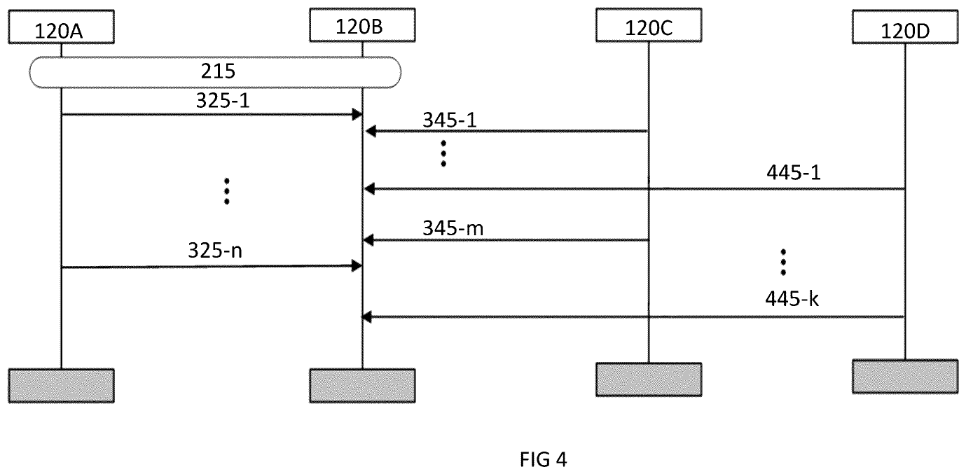

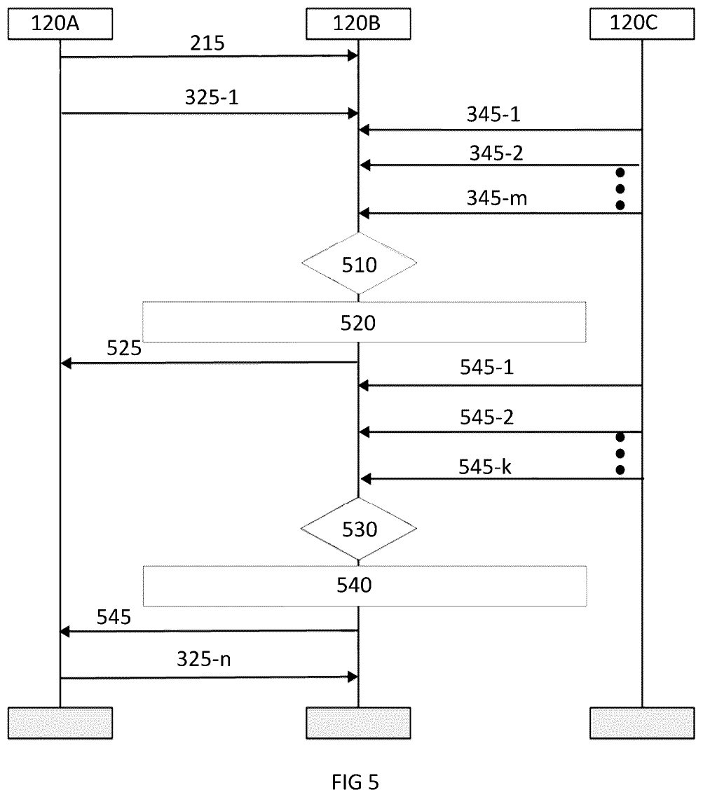

FIG. 4 shows another example embodiment of a signaling diagram;

FIG. 5 shows another example embodiment of a signaling diagram for providing impact information;

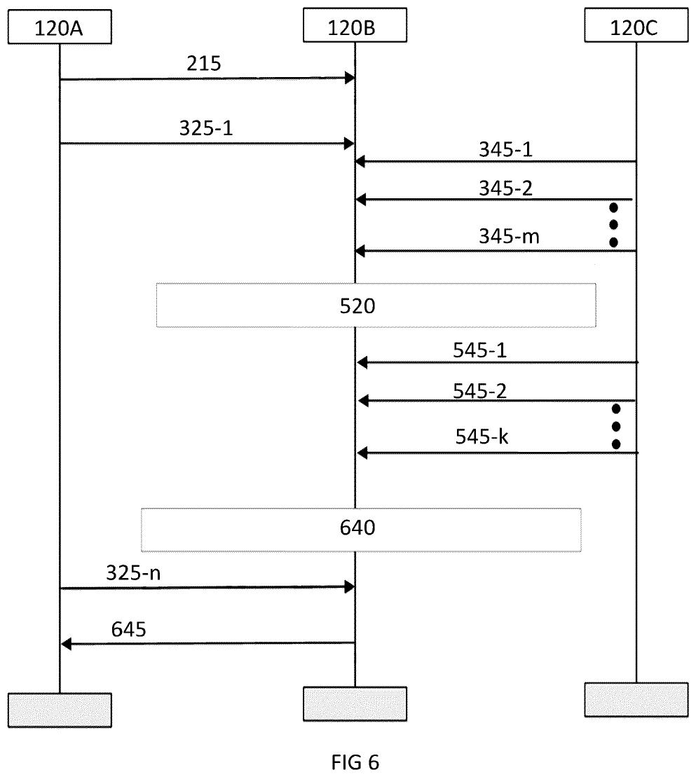

FIG. 6 shows another example embodiment of a signaling diagram for providing impact information;

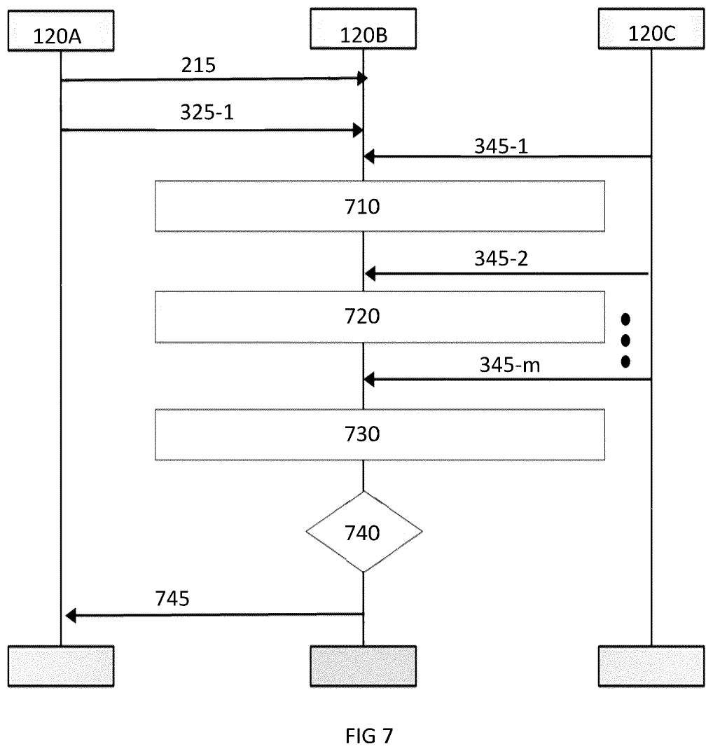

FIG. 7 shows another example embodiment of a signaling diagram for providing impact information;

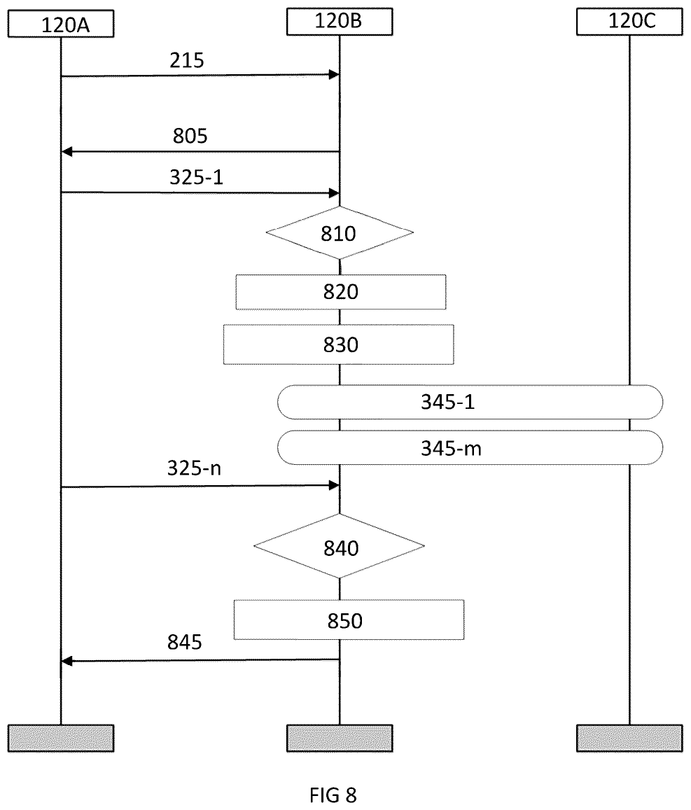

FIG. 8 shows another example embodiment of a signaling diagram for providing impact information;

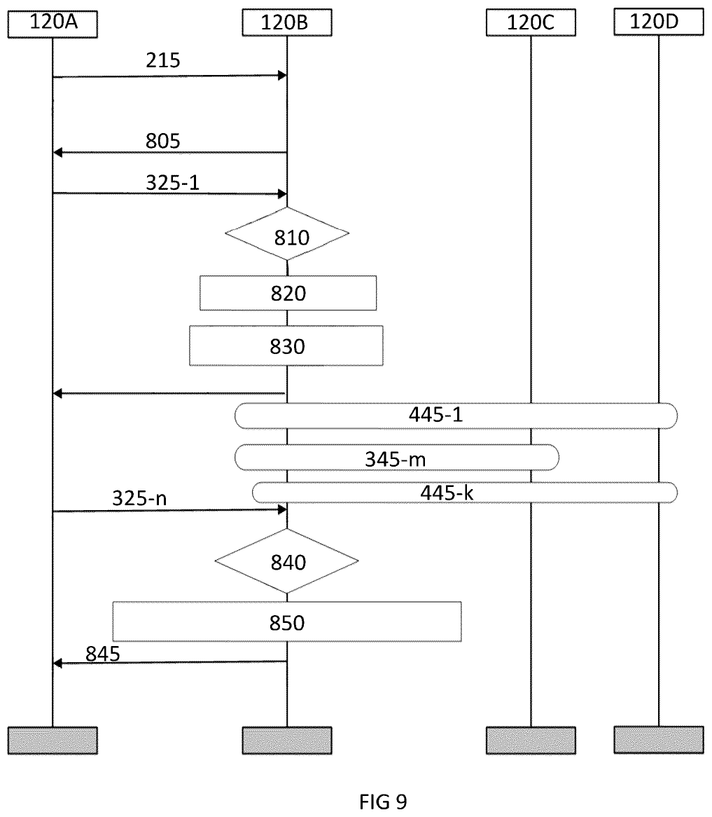

FIG. 9 shows another example embodiment of a signaling diagram for providing impact information;

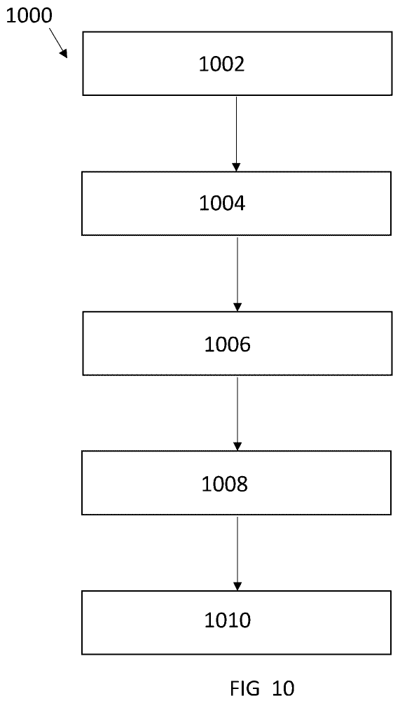

FIG. 10 shows an example embodiment of a method for providing impact information;

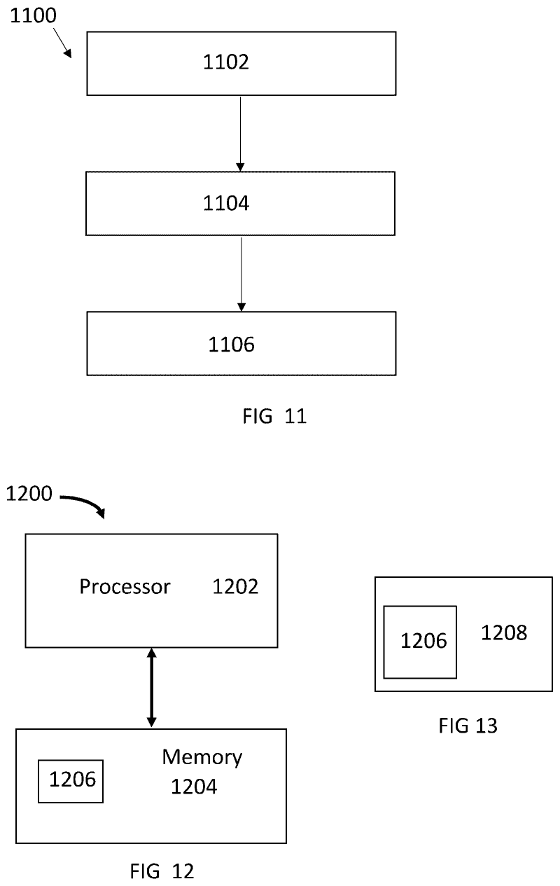

FIG. 11 shows another example embodiment of a method for providing impact information;

FIG. 12 shows an example embodiment of a controller; and

FIG. 13 shows an example embodiment of a delivery mechanism.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### Definitions

3GPP Third Generation Partnership Project
5G 5^{th} Generation
AI Artificial Intelligence
BS Base Station
E-UTRAN Evolved Universal Terrestrial Radio Access Network
FPGA Field-Programmable Gate Array
gNB 5G/NR base station
LTE Long-Term Evolution
ML Machine Learning
NG-RAN Next Generation Radio Access Network
NR New Radio
OAM Operation, Administration, and Management
QoE Quality of Experience
QoS Quality of Service
RAN Radio Access Network
RRC Radio Resource Control
UE User Equipment
UI User Interface
XnAP Xn Application Protocol

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124, and the nodes 110, 120, 129 are wireless network nodes.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) 110 and the access nodes 120 are base stations.

In the particular example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

A user equipment 110 comprises a mobile equipment. Where reference is made to user equipment that reference includes and encompasses, wherever possible, a reference to mobile equipment.

To meet the 5G network requirements of key performance and the demands of the unprecedented growth of the mobile subscribers, millions of base stations (BSs) are being deployed. Such rapid growth brings the issues of optimizing a network. Artificial intelligence (AI)/machine learning (ML) techniques can be utilized to automate this optimisation. Some use cases for AI/ML enabled RAN are network energy saving, load balancing and mobility optimization.

Cells can be distinguished as “coverage cells”, deployed to provide basic coverage and “capacity cells”, deployed to increase capacity. Capacity cells, and their corresponding nodes 120, could be switched off when the additional capacity is not needed in order to increase network energy efficiency. Traffic can be offloaded from nodes which are switched off to other nodes. This may involve performing handovers between two nodes 120, such as handovers of UE 110.

Artificial intelligence (AI)/machine learning (ML) techniques require the input of data which is collected by measurements of network parameters. One such parameter is an energy cost metric, capturing information related to the energy consumption or energy efficiency of the network 100. The energy cost can be a node level metric of energy cost or a cell level metric of energy cost. In some examples, the energy cost metric reflects a node level total energy consumption, energy efficiency or a normalized value reflecting the energy consumption or energy efficiency at a node level. In some examples, the energy cost metric reflects a cell level total energy consumption, energy efficiency or a normalized value reflecting the energy cost or energy efficiency at a cell level. In some examples, the energy cost metric could comprise a sum of additional energy consumption at a target node or cell after at least one user equipment 110 is handed over to it. In other examples, the energy cost metric could comprise a decrease of energy consumption at a source node or cell after at least one user equipment 110 is offloaded to different target nodes. In some examples, the energy cost metric comprises information that depends on the additional load caused by serving at least one additional user equipment 110.

Energy cost may also be an inferred (predicted or estimated) value. An inferred energy cost may represent a prediction or estimate of a node level total energy consumption or energy efficiency, or a normalized value reflecting the energy consumption or energy efficiency at a node level. An inferred energy cost may also represent a prediction or estimate of a cell level total energy consumption or energy efficiency, or a normalized value reflecting the energy consumption or energy efficiency at a cell level. If an inferred energy cost represents the energy cost value assuming that an additional load is served, the measured energy cost may represent the actual energy cost value, e.g., after an additional load is transferred at a target node. If the inferred energy cost represents the delta increase of the energy cost value assuming that an additional load is served, the measured energy cost may represent the delta increase (difference) of the energy cost value after an additional load is transferred.

Even though energy cost may reflect an energy consumption (with respect to a number of joules consumed by a network node or cell) or an energy efficiency (with respect to a number of bits consumed per joule), information exchanged between the network nodes may be an abstraction and/or a normalization of the measurements.

Normalization of the energy cost metric at node level or cell level can be done through operations, administration, and maintenance (OAM) in order to enable different nodes to understand in the same way an energy cost measurement provided by neighbouring nodes. Normalization may abstract the energy cost measurement within a range for example from 0 to a maximum range such as 100 or 1000 or 10000. When a node reports energy cost values closer to 0 it has a smaller energy cost measurement and when it reports energy cost values closer to the defined maximum it has a higher energy cost measurement. Normalization by OAM can also be used to scale accordingly the energy cost reported by a network node located at a central location and serving a large number of user equipment 110 as opposed to a network node that is located at a more remote area and serving less user equipment 110. So, for example, when those two nodes report the same energy cost value, the latter is having a higher normalized energy cost at the remote node. Normalization can be also used to scale the energy cost to reflect a node's willingness or unwillingness to participate an energy saving action. For example a node may be normalized by OAM to report a higher normalized energy cost value to indicate its unwillingness to participate to an offloading. This could be because a node may be also running other ML operations or algorithms (such as load balancing) which could be creating conflicting decisions at the node.

In order to normalize an energy cost value OAM could provide rules to the NG-RAN nodes on how to scale their measured energy cost values depending on their location, served traffic, cell size, number of concurrent AI/ML operations or executed AI/ML algorithms, to give a few examples. The rules could instruct a network node to scale down the energy cost reported by the network node to smaller values with respect to the consumed energy or inferred consumed energy in order to indicate a preference in choosing this node for decisions related to energy efficiency. The rules could instruct a network node to scale up the energy cost reported by the network node to higher values with respect to the consumed energy or inferred consumed energy in order to indicate to other network nodes an unwillingness to participate decisions related to energy efficiency.

FIG. 2 shows an example signaling chart according to examples of the disclosure. The signaling chart shows a first network node 120A, a second network node 120B, and a third network node 120C. The first network node 120A, second network node 120B, and third network node 120C may be the access nodes 120 as illustrated in FIG. 1, and can each be a base station 120 such as a gNB 120. The first network node 120A acts a requesting network node 120A, the second network node 120B acts as a target network node 120B, and the third network node 120C is another network node 120C or an impacting network node 120C. In some examples, the first network node 120A and the second network node 120B are neighboring nodes. In some examples, the first network node 120A, second network node 120B, and third network node 120C are neighboring nodes.

A first apparatus 120A is for the first network node 120A, and a second apparatus 120B is for the second network node 120B. In some examples a first apparatus 120A comprises the first network node 120A, and a second apparatus 120B comprises the second network node 120B.

At block 210 the requesting network node 120A sends a message 215 to the target network node 120B. The message 215 comprises a request for measurement information of a measurement of the target network node 120B. The message 215 can be considered a request message 215. In some examples, the measurement is based on an energy cost metric and the measurement information comprises the energy cost value. The measurement can be a node-based measurement or a cell-based measurement. In some other examples, the measurement may be related to another metric such as UE performance feedback, for example, related to an energy cost metric measured by a handed over UE to a target node or related to other UE performance such as throughput, uplink or downlink delay, packet loss rate, quality of experience (QoE) or quality of service (QoS) measurement experienced and reported by a UE at a target cell.

The message 215 also comprises a message field requesting impact information of an impact 235 of at least one other network node 120C on the measurement. In some examples the message field comprises a flag requesting the impact information. The message 215 may comprise one or more information elements.

In some examples the measurement relates to traffic offloading from the requesting network node 120A to the target network node 120B. Offloading traffic may comprise performing at least one handover from the requesting network node 120A to the target network node 120B, and thus the measurement may relate to at least one handover from the requesting network node 120A to the target network node 120B. In some examples the measurement information comprises the energy cost of at least one handover from the requesting node 120A to the target node 120B.

At block 220 the target network node 120B receives the message 215 from the requesting network node 120A.

At block 230 the target network node 120B acquires the measurement information. In some examples, acquiring the measurement information comprises the target network node 120B performing the measurement related to the requesting network node 120A. In other examples the measurement is performed by a different network node 120.

The measurement is affected by an impact 235 of at least one other network node 120C. The impact 235 may be a direct impact 235 by the at least one other network node 120C on the target network node 120B. In some examples, the impact 235 is based at least in part on the at least one other network node 120C sending a message to the target network node 120B. The message may cause processing in the target network node 120B and possibly also transmission of a signal from the target network node 120B, thus increasing energy consumption in the target network node 120B. In some examples, the impact 235 is the impact 235 on the measurement of at least one traffic offloading action between the at least one other network node 120C and the target network node 120B. The at least one traffic offloading action may comprise at least one handover between the target network node 120B and the at least one other network node 120C. A handover from the at least one other network node 120C to the target network node 120B adds a new user equipment 110 to be served by the target network node, thus increasing its node level (or cell level) energy consumption. In other examples, the impact 235 may be due to cell congestion and/or cell interference or remote interference. The cell congestion may increase the energy cost at the target network node 120B either linearly or non-linearly on the basis of the number of served user equipment 110. High interference levels may also imply transmissions at higher transmission power levels at the NG-RAN nodes 120 but also at the UE 110 side and therefore increase the measured energy cost values by a node 120 or by a UE 110 when it reports UE performance to the network. High interference levels may also trigger additional signal processing functions that increases the energy cost.

At block 240 the target network node 120B acquires the impact information. In some examples acquiring the impact information comprises the target network node 120B measuring the impact information and/or calculating an impact level. In other examples this may be performed by a different node 120. In some examples the target network node 120B determines whether to acquire impact information based on the request message 215 received.

At block 250 the target network node 120B sends the measurement information and the impact information to the requesting network node 120A. In some examples the target network node 120B sends a message 255 comprising the measurement information and the impact information to the requesting network node 120A. This message 255 can be considered a reporting message 255.

At block 260 the requesting network node 120A receives, from the target network node 120B, the measurement information and the impact information. In some examples this involves receiving the reporting message 255. In some examples the measurement information is for input to an AI/ML model. The requesting network node 120A may input the measurement information and/or the input information to an AI/ML model.

At block 270 the requesting network node 120A, based on the measurement information and the impact information, performs, at least one action related to traffic offloading. In some, but not necessarily all, examples performing this at least one action involves offloading traffic between the requesting network node 120A and the target network node 120B. Offloading traffic between the requesting network node 120A and the target network node 120B may comprise performing at least one handover from the requesting network node 120A to the target network node 120B. In some examples a decision is made based on measurement information at the local (requesting) network node 120B and the impact information and measurement information received by the target network node 120A.

At block 280 the target network node 120B, based on the sent measurement information and the sent impact information, performs at least one action related to traffic offloading. In some, but not necessarily all, examples performing the at least one action involves offloading traffic from the requesting network node 120A to the target network node 120B. Performing the at least one action can comprise receiving handover configuration(s) from the requesting network node 120A and/or performing handovers of UEs 110 as the target network node 120B for the handovers. In some examples, the requesting node 120A sends a message 215 to the target network node 120B comprising a request for measurement information of a measurement on an energy cost, the measurement relating to traffic offloading from the requesting network node 120A to the target network node 120B. The target network node 120B subsequently makes the energy cost measurement. The purpose of this may be to determine the energy cost caused by the offloading traffic from the requesting node 120A. This can be used to determine actions to be performed, and can be input to an AI/ML algorithm to determine such actions. The structure and operational logic of the AI/ML algorithm is beyond the scope of this disclosure. Several state-of-the-art algorithms may be suitable for determining the number of offloaded connections on the basis of the measurement information and the impact information received from the target network node 120B.

However, the measurement may be impacted by the impact 235 of other network nodes 120C. For example, by at least one traffic offloading action between the target network node 120B and at least one other network node 120C. This may cause the measurement to no longer be accurate for the energy cost caused by the offloading traffic from the requesting node 120A. This is because the energy cost of the target network node 120B during the measurements will increase due to concurrent offloading traffic from both the requesting network node 120A and the other network node 120C.

To account for this, the requesting node 120A requests impact information from the target node 120B. Once received, this impact information can be used to determine the energy cost caused by the offloading traffic of the requesting node 120A. This provides the technical effect of improving the accuracy of measured metrics, such as an inferred (predicted or estimated) energy cost of the traffic offloading from the requesting node 120A to the target network node 120B. This leads to better decision making and thus an improved and more efficient radio access network.

The impact information comprises an impact level. In some examples, the impact level is the (additional) energy cost due to the impact 235 of the at least one other network node 120C on the measurement. In some examples, the impact level is dependent on an additional load and is represented as a fraction of the (additional) energy cost due to the impact 235 of the at least one other network node 120C on the measurement.

The impact level could be represented through a percentage, in the range 0 to 100, of the additional energy cost due to the additional load being transferred to node 120B from impact 235 as opposed to the additional energy cost corresponding to the actions of node 120A impacting node 120B. A value of 0 could signify that there is no other impact to the energy cost measurement from other network nodes (namely the reported energy cost by node 120B corresponds purely to offloading actions of node 120A). A value of 100 could correspond to a very high impact in the energy cost measurement originating from other network nodes. Naturally, the impact level could alternatively take an integer value, possibly higher than 100. In other examples, the impact level is a qualitative indicator of the impact 235. For example, the impact level could be low, medium or high.

In some examples, the impact level is based at least in part on the number of the UE 110 handovers to the target node 120B from the requesting node 120A, and the number of the UE 110 handovers to the target node 120B from the at least one other node 120C. For example, the impact level may be based on the ratio or relation between the number of handovers from the requesting node 120A and the number of handovers from the at least one other node 120C. If the portion of handovers from the other node(s) 120C is small compared to the number of handovers from the requesting node, the impact level is low. In other examples, the impact level is based at least in part on physical resource block usage. For example, the physical resource block usage of the UE 110 handovers to the target node 120B from the requesting node 120A, compared to the physical resource block usage of the UE 110 handovers to the target node 120B from the at least one other node 120C.

In some examples, the impact information comprises an impact indicator which indicates whether the impact level includes any impact 235 from ongoing offloading traffic. The impact indicator can indicate whether the impact from other network nodes 120C has finished or whether it is ongoing during the measurements. The impact indicator can, therefore, indicate if an impact 235 is ongoing or whether it has completed.

In some examples, the impact information comprises a duration of the impact 235. For example, the duration of traffic offloading from an other network node 120C which impacts the measurement. The duration of the impact 235 may be an expected or predicted duration. The target node 120B may predict the duration of impact 235. For example, based on the number of handovers expected in the traffic offloading from the other node 120C. In some examples the other network node 120C may send the expected or predicted duration, and/or the number of expected handovers, to the target network node 120B.

In some examples the request message 215 further comprises configuration information. The configuration information is for configuring the measurement and/or configuring sending the measurement information and the impact information from the target network node 120B.

In some examples the configuration information specifies the metric of the measurement. In some examples the metric is an energy cost measured at a NG-RAN node.

The configuration information can comprise instructions for the target network node 120B of when to send the impact information and/or the measurement information. For example, the configuration information may comprise instructions to send the impact information in response to an offloading action between the target network node 120B and at least one other network node 120C. In some other examples, the configuration information comprises instructions to send the impact information when a certain number of handover actions (corresponding, for example, to an offloading plan) is complete. In some other examples, the configuration information comprises instructions to send the impact information when the impact level exceeds a threshold.; In some other examples, the configuration information comprises instructions to send the impact information when a ratio of the impact level to the energy cost exceeding a threshold; and/or to the network node receiving an indication that the offloading traffic is complete. The target node 120B can send the measurement information and impact information based on the configuration information.

In some examples, a requesting node 120A may request impact information with respect to a number of handover actions towards a target node. In those examples, the requesting node 120A can send a further message comprising an indication that the offloading traffic is complete. In response to receiving the indication that the offloading traffic is complete, the target node 120B can send the impact information. This provides certainty for the target node 120B that the offloading action is complete and no more impact will occur from this offloading action. This certainty is achieved, even in situations where some handovers have failed and so the number of handovers received by the target mode 120B is lower than expected; the target node can calculate the impact information based on all the handover actions from the requesting node starting from the first handover and until the indication that the handover traffic is complete.

In some examples, the configuration information comprises instructions to send the impact information substantially immediately after the impact information is acquired. In some examples this is within 500 ms after the impact information is acquired, In other examples this is within 5 or 10 seconds after the impact information is acquired. This can involve the impact information and measurement information being sent in different messages 255. In other examples, the configuration information comprises instructions to send the impact information concurrent with the measurement information. For example, to send the impact information combined with the measurement information in a single message 255. In some examples sending the impact information is delayed until the measurement information is available to send, whilst in others sending the impact information is not delayed.

FIGS. 3a and 3b show example signaling charts according to examples of the disclosure. The signaling charts of FIGS. 3a and 3b can comprise some or all of the features of the signaling chart of FIG. 2. FIGS. 3a and 3b both illustrate scenarios where a plurality of handovers 325, 345 occur from both the requesting network node 120A to the target network node 120B, and from another network node 120C to the target network node 120B. The handovers 325, 345 may be handovers of at least one user equipment 110.

In both FIG. 3a and FIG. 3b, at block 315 the message 215 comprising the request for measurement information of the measurement is sent by the requesting network node 120A and received by the target network node 120B.

A plurality of handovers 325 occur between the requesting network node 120A and the target network node 120B, with handover 325-1 being the first and 325-n being the last of n handovers. The illustrated three dots indicate that a number of other handovers may occur. The illustrated handovers are consecutive handovers. The plurality of handovers 325 are considered an offloading action 325.

A plurality of handovers 345 occur between the other network node 120C and the target network node 120B, with handover 345-1 being the first and 345-m being the last of m handovers. Other handovers may occur. The illustrated handovers are consecutive handovers. The plurality of handovers 345 are considered an offloading action 345 and/or an offloading plan 345.

In FIG. 3a, the first handover 325-1 from the requesting network node 120A to the target network node 120B is before the first handover 345-1 from the other network node 120C to the target network node 120B. The last handover 325-n from the requesting network node 120A to the target network node 120B is after the last handover 345-m from the other network node 120C to the target network node 120B. Therefore, the offloading action 325 from the requesting network node 120A to the target network node 120B can be considered to be synchronous/fully concurrent with the offloading action 325 from the other network node 120C to the target network node 120B. A measurement related to the offloading action 325 from the requesting network node 120A to the target network node 120B will thus, be impacted by all of the handovers 345 corresponding to an offloading action from the other network node 120C to the target network node 120B.

In FIG. 3b, the first handover 325-1 from the requesting network node 120A to the target network node 120B is before the first handover 345-1 from the other network node 120C to the target network node 120B. The last handover 325-n from the requesting network node 120A to the target network node 120B is before the last handover 345-m from the other network node 120C to the target network node 120B. Therefore, the offloading action 325 from the requesting network node 120A to the target network node 120B can be considered to be partially synchronous/partially concurrent with the offloading action 325 from the other network node 120C to the target network node 120B. A measurement related to the offloading action 325 from the requesting network node 120A to the target network node 120B will thus, be impacted by only some of the handovers 345 of the offloading plan from the other network node 120C to the target network node 120B.

Although a plurality of handovers are shown, in other examples a offloading action may comprise only a single handover.

In some examples, multiple other impacting network nodes 120C, 120D may have an impact 235 on the measurement. FIG. 4 shows an example signaling chart according to examples of the disclosure. The signaling chart of FIG. 4 can comprise some or all of the features of the signaling charts of FIGS. 2, 3a and 3b. FIG. 4 comprises a second other/impacting network node 120D, similar to the first other/impacting network node 120C.

In FIG. 4 there are a plurality of handovers 445 corresponding to an offloading plan from the second impacting network node 120D to the target network node 120B, which may be considered an offloading action 445. These handovers 445 can also have an impact 235 on the measurement. The impact level of the impact information may concern the combined impact of offloading actions 345, 445 of both impacting network nodes 120C, 120D on the measurement.

As depicted in the figure, the offloading action of the first impacting network node 120C is synchronous/fully concurrent with the offloading action 325 of the requesting network node 120A, whereas the offloading action of the second impacting network node 120D is partially synchronous/partially concurrent with the offloading action 325 of the requesting network node 120A.

A metric named energy cost has recently been introduced to evaluate the impact of AI/ML energy saving actions to neighbouring nodes 120. The energy cost provides a representation of the energy consumption at an NG-RAN node 120. NG-RAN nodes 120 exchange the energy cost with neighbouring NG-RAN nodes upon request. The energy cost is encoded as an index, normalized by rules provided by operations, administration, and maintenance (OAM).

In general, the measurements that have been exchanged over RAN interfaces are cell level measurements. However an energy cost may not always be calculated on a cell level when different cells share physical resources. For such scenarios, an energy cost of coarser granularity is needed. To that end, the energy cost metric may be a node level measurement.

Energy cost measurement is often coupled with an offloading action performed by a node 120. An offloading action comprises handing over one or more UE(s) to a neighbouring NG-RAN node 120. This handover may be triggered by a number of use cases, such as AI/ML Network Energy Saving (for example, cell/beam switch-off), AI/ML Load Balancing or AI/ML Mobility Optimization.

Exchange of an energy cost measurement after an offloading action is sufficient in a simple scenario involving two NG-RAN nodes 120 where a first NG-RAN node 120A triggers an offloading action to a second NG-RAN node 120B and where there are no other offloading actions towards the second NG-RAN node 120B by other NG-RAN nodes 120C, 120D. In this scenario, if the second NG-RAN node 120B periodically reports an energy cost measurement (as measured at the second NG-RAN node 120B) to the first NG-RAN node 120A, this energy cost reflects purely the impact to the energy cost of NG-RAN node 120B from the offloading actions of NG-RAN node 120A, according to the configured measurement setup. In this scenario, the effect on the energy cost measurement is due to the offloading actions of the first NG-RAN node 120A since there are no other concurrent offloading actions to the second NG-RAN node 120B. Hence, the reported values of energy cost correspond to an additional load at the second NG-RAN node 120B due to the offloaded UE(s).

However, it may be an overly simplified assumption that a single NG-RAN node performs offloading actions towards a second NG-RAN node. In practice, for instance energy saving is enabled in the RAN during low load situations e.g., in the evening, and it is highly likely that offloading from a number of (coverage) cells may take place to the same (capacity) cell for energy saving purposes. When concurrent offloading actions take place from multiple NG-RAN nodes 120 to another NG-RAN node 120B then calculating the impact in terms of the energy cost (or another measurement) from a single NG-RAN node 120A becomes more complex. In this case, the reported energy cost may be polluted/impacted by the cost in energy corresponding to offloading actions from other NG-RAN nodes 120. In a scenario, if an energy cost is periodically reported from the second NG-RAN node 120B to the first NG-RAN node 120A the reported measurement may also include the impact 235 due to the offloading action from the third NG-RAN node 120C to the second NG-RAN node 120B. The second NG-RAN node 120B can calculate the impairment from other nodes 120C, 120D and report to the first NG-RAN node 120A. This can be extended by providing a solution of how to calculate the impact 235 of concurrent offloading actions and how to report such information to the requesting node 120A.

When a NG-RAN node 120A executes an offloading action to another NG-RAN node 120B and requests an energy cost measurement corresponding to the offloading action, it may not possible for the requesting node 120A to determine if the provided energy cost from NG-RAN node 120B corresponds only to the first node's 120A offloading actions or whether it is further impacted by offloading actions from other NG-RAN nodes 120C, 120D. Such scenarios can be highly likely since as mentioned earlier network energy saving operations will be scheduled by the network when the network load is low, for example in the evening hours. Hence low load condition may be detected by more than one NG-RAN node 120 at any given time which may trigger the one or more NG-RAN nodes 120 to initiate a cell switch-off and to initiate offloading, such as handovers of UE 110.

Also, a first NG-RAN node 120A may need to determine the collective impact 235 of the other offloading actions at a second NG-RAN node 120B, i.e., the impact to the energy cost from the UE(s) 110 that are handed over from other neighbouring NG-RAN nodes 120C, 120D rather than the per handover impact 235.

Concurrent offloading actions by neighbouring NG-RAN nodes 120C, 120D can be classified as fully concurrent/synchronous/fully overlapping (fully within the other offloading action duration) or partially concurrent/partially synchronous/partially overlapping (extends beyond the other offloading action duration), as explained in examples earlier.

### Scenario 1: Fully Concurrent

In this Scenario an offloading action from the first NG-RAN node 120A to the second NG-RAN node 120B comprises n handovers and an offloading action from the third NG-RAN node 120C to the second NG-RAN node 120B comprises m handovers. The offloading can be considered is fully concurrent if the offloading action from a third NG-RAN node 120C to a second NG-RAN node 120B is fully within the offloading action from a first NG-RAN node 120A to the second NG-RAN node 120B, as shown in FIG. 3a. This means that the handovers for all UE(s) 110 that the third NG-RAN node 120C wishes to offload to the second NG-RAN node 120B are completed before the handovers from the first NG-RAN node 120A to the second NG-RAN node 120B are completed.

### Scenario 2: Partially Concurrent

As in Scenario 1, an offloading action from the first NG-RAN node 120A to the second NG-RAN node 120B comprises n handovers and an offloading action from the third NG-RAN node 120C to the second NG-RAN node 120B comprises m handovers. The offloading can be considered partially concurrent if the offloading action from a third NG-RAN node 120C to a second NG-RAN node 120B still continues when the offloading action from a first NG-RAN node 120A to the second NG-RAN node 120B completes, as shown in FIG. 3b. As depicted in FIG. 3b, the offloading action from the third NG-RAN node 120C still continues when the offloading action from the first NG-RAN node 120A completes, i.e., all UE handovers corresponding to an offloading plan from the third NG-RAN node 120C to the second NG-RAN node 120B are not completed when the last handover of the offloading plan of the first NG-RAN node 120A to the second NG-RAN node 120B is completed.

It is possible that both scenarios occur, as shown in FIG. 4. As depicted in the figure, the offloading action from the third RAN Node 120C is completed while the offloading action from the fourth RAN Node 120D is not completed when both are compared to the offloading action from the first RAN Node 120A.

In some examples, the metric is not energy cost and/or the impact 235 is not due to handovers. For example, when a target cell 120B which is collecting UE performance feedback measurements for UE(s) 110 offloaded from a source cell 120A and if its operation is impacted due to other conditions (for example, it becomes a victim of inter-cell interference or remote interference), UE performance measurements will be negatively impacted. If there is no possibility to indicate this information to the requesting node 120A, the requesting node 120A may incorrectly consider the poor UE performance feedback associated with AI/ML action performed, while poor UE performance is actually associated with the cell operational impact at the target NG-RAN node or with other external factors such as remote interference. Examples of the disclosure allow this impact to be reported to the requesting node 120A and for the correct UE Performance feedback to be determined, or at least the impact to be considered. The requesting node 120A may use the impact information when making further traffic offloading decisions, for example a decision regarding performing handovers of UEs 110 to the target node 120B.

Examples of the disclosure provide a method to enable a first NG-RAN node 120A requesting from a second NG-RAN node 120B, a node or cell level metric evaluated at the second NG-RAN node 120B, to determine an impact 235 on the reported node or cell level metric due to offloading actions taken at one or more third NG-RAN nodes 120C. An indication is provided to enable a NG-RAN node 120B to determine events that may impact or pollute the requested node or cell level metric and introduce a level of impact in the reported information. The node or cell level metric under consideration may be an energy cost metric.

Specifically, examples of the disclosure provide a mechanism for a first NG-RAN node 120A, requesting a node-level metric, for example, of energy cost to indicate to a second NG-RAN node 120B that does the reporting to report also whether the reported information (for example, energy cost information) is impacted by other offloading actions by one or more third NG-RAN nodes 120C, 120D.

This mechanism can be implemented by means of a procedure that can configure reporting of a metric (for example, energy cost) together with a flag requesting the reporting node to provide information whether the reported metric/energy cost is impacted by other offloading actions. The reported metric may be a cell-level metric or a node-level metric. In some examples, reporting configuration may be implemented through a class 1 XnAP procedure, that is based on a request/response message sequence.

Additionally there is a procedure where the actual metric (such as energy cost) is reported. In some examples, this may be implemented through a class 2 XnAP procedure. In some examples, the reported measurement corresponding to the metric may be associated with a measurement ID. This measurement ID (meas ID) is used in the message 215 comprising a request for measurement information from NG-RAN node 120A towards NG-RAN node 120B to enable NG-RAN node 120B associate the impact 235 of handovers from other NG-RAN nodes 120C to the requested measurement from NG-RAN node 120A.

In the request message 215, comprising a request for measurement information, event-based reporting triggers can be configured based on thresholds, offloading actions and/or additional load across offloading actions across neighboring nodes. In addition, there may be a further message by the first node 120A to explicitly signal to the second node 120B the end of an offloading action to enable the latter to determine an impact 235 on the calculated energy cost metric with respect to the overall offloading action (comprising a number of handovers towards it) of the first node 120A. In some examples, the first network node 120A sends the request message 215 to the second network node 120B. The request message 215 comprises a message ID associated with the first network node 120A (meas ID 1), an impact flag, a field identifying the requested measurement corresponding to a metric, and a field identifying an event trigger for reporting the impact 235. The second network node 120B can then send an acknowledgement comprising a message ID associated with the second network node 120B (meas ID 2). The first network node 120A subsequently initiates a handover to the second network node 120B, the handover can include meas ID 1 and meas ID 2. The second network node 120B then sends an impact update comprising the impact information. This can include an impact description, an impact level and information concerning the impacting node(s) 120C, 120D.

Benefits of the described procedures include enabling a requesting node 120A to request how its offloading actions impact a node- or cell-level metric value (for example, based on an energy cost) at a neighbouring node 120B by allowing the latter to provide information to the requesting node 120A regarding impacts of offloading actions of other nodes 120C, 120D in the reported metric values.

The following section describes the different parameters appearing in the measurements reporting procedures, for example, to describe an energy cost resulting from an offloading action. Even though parts of this disclosure refer to energy cost as the metric it should be understood that the methods can be used for other metrics as well, including other node-level metrics and other cell-level metrics.

In some, but not necessarily all, examples a configuration for performance metrics is included in the request message 215 (for example, in a AI/ML information request 215 or other request message 215 to determine a node-level or cell-level impact to a metric measurement) as shown in the following table:

TABLE 1
Fields concerning configuration in the request message 215
Configuration Description
Metric (Node Level or Cell Level)

Impact Event Type
Handover/Offloading Action based
Total Additional Load Based
Threshold Based
Impact Reporting Configuration
Immediate
Combined with Metric Report

The request message 215 may include a subset or all of the fields of Table 1.

In some examples, information about the impacting factors in the reported values in the reporting message(s) 255, which report the impact information from the second network node 120B to the first network node 120A, are as shown in the table below:

TABLE 2
Fields concerning the impact 235 in a reporting message 255
Impact Description

Impact Level
Impacting NG-RAN node Information
Partial Impact Indicator

The reporting message 255 may include a subset or all the fields of Table 2.

In some examples, the configuration information in the request message 215 contains some or all of the following information. The information may be information element(s).

Impact Flag: This indication enables a NG-RAN node 120A to indicate to another NG-RAN node 120B whether it wishes to be notified about impacts to the requested metric (such as energy cost or UE performance metric) due to other concurrent offloading actions from other NG-RAN nodes 120C, 120D.

Metric: This indicates a metric requested by a node 120A. This may be an energy cost metric corresponding to an energy consumption or energy efficiency measured at a network node level or at cell-level. It may also be a UE performance metric e.g., a throughput, uplink or downlink delay, packet loss rate, a QoE metric e.g., related to a UE buffer size, a UE-related energy consumption to give a few examples. For example, a NG-RAN node 120A may request a neighbouring NG-RAN node 120B how UE performance metrics of UEs being served by NG-RAN node 120B is impacted from the actions of NG-RAN node 120A or whether the impacts to UE performance are due to actions originating by other NG-RAN node 120C. However, other node-level or cell-level performance metrics measured at a NG-RAN node or performance metrics measured by a UE can be indicated.

Event Trigger: This indicates the events for which an impact 235 is notified to a requesting node 120A:
Threshold-based: In this option, when the metric is impacted by a configured threshold/margin, then the notification 255 of the impact 235 is triggered. For example, a NG-RAN Node 120A can indicate that it shall be notified if the energy cost is impacted by more than 10% or by more than 20% by actions corresponding to other NG-RAN nodes 120C, 120D.
Handover or Offloading Action based: In this option, the notification 255 of the impact 235 is triggered for each handover or offloading action from any other NG-RAN node 120C, 120D while the offloading action from the requesting node 120A is still in progress. In case of handover-based, a NG-RAN node 120B sends the notification 255 for each handover action received by a neighbouring NG-RAN node 120C (corresponding to an additional load and hence to an additional impact towards the NG-RAN node 120B). In case of offloading action based, a NG-RAN node 120B can determine the ending of an offloading action (corresponding to a number of handovers) through an indicator that indicates the end of an offloading action provided to it by the neighbour 120C performing the offloading. When this indicator is received by NG-RAN node 120B from a neighbouring NG-RAN node 120C, it can trigger reporting of the corresponding impact towards NG-RAN node 120A.
Total Additional Load based: In this option, the notification 255 of the impact 235 is triggered with the consolidated impact of offloading actions from neighbouring nodes 120C, 120D. This may be the total impact in terms of the total additional load, e.g. when the total additional load from the neighbouring nodes 120C, 120D exceeds a certain threshold, the notification 255 of the impact 235 is triggered. The total additional load may be measured in terms of a number of offloading actions or in terms of an additional traffic load resulting from the offloading from the neighbouring nodes 120C, 120D.

Reporting Configuration: The requesting message 215 can indicate whether the impacting notification 255 shall be done immediately or when the measurement information on the performance metric is reported from the second NG-RAN node 120B. Accordingly, this information element can be set to immediate or combined with metric reporting.

In addition, in some examples, indicating of the impact 235 is as follows:
Impact Level: This information element denotes the impacting factor in the reported performance metric, which may be energy cost, caused by other concurrent offloading actions. The impact level can be calculated and/or indicated in a number of different ways. Two examples are provided below:
   Active UE Count: can be based on size of the offloading action i.e., number of active UE(s) 110 handed over. For example, if the first NG-RAN node 120A triggers an offloading action with 50 UE(s) to the second NG-RAN node 120B and if the third NG-RAN node 120C triggers a concurrent offloading action with 10 UE(s), the impact level to the energy cost could be indicated as 20% calculated by:

number of UE(s) in concurrent offloading action÷number of UE(s) in the offloading action from the requesting node 120A (10/50).
When the requesting node 120A receives the energy cost measurement together with an impact level of 20%, it can interpret that the reported energy cost additionally includes cost of 20% UE(s) handed over from other concurrent offloading plans.
If a target node 120B indicates the impact level as 0% (in some examples the target node 120B might not indicate this explicitly to the requesting node 120A since it can be deduced, for example, through the absence of an impact level value) then there are no concurrent offloading actions and hence the requesting node 120A identifies that the reported energy cost is solely due to its own offloading of traffic.
Share of energy cost: In some examples, energy cost is directly proportional to the amount of physical resource blocks (PRBs) utilized per UE. Examples of the disclosure include the target node 120B indicating the share of average PRB utilization of the UE(s) 110 offloaded from requesting node 120A compared to the UE(s) 110 offloaded from the concurrent offloading from other nodes 120C, 120D. For example, if we consider average utilization of 100 PRBs in which 60 PRBs are allocated to the UE(s) 110 from the requesting node 120A while 40 PRBs are allocated to the UE(s) 110 from other concurrent offloading actions from other nodes 120C, 120D, this could lead to an impact level of 40/60=66.6%. This enables the requesting node 120A to identify that N number of additional active UE(s) are contributing to X % in the reported energy cost Y. Calculating the impact level based on PRB utilization is likely to be more accurate than using an active UE count, however, it will use more computational resources.
Impacting Node Information: In some examples the impact information includes additional information about the other node(s) 120C, 120D that caused the impact 235. This indicates the list of node(s) 120C, 120D that triggered concurrent offloading actions overlapping with the offloading action from the requesting node 120A. Additionally the cells of those nodes that were involved in the concurrent offloading actions may be listed per node. In some examples, when the impact level is substantially 0%, this indication is not included. Additionally an impact scope may be included to indicate a number of cells that are impacted. In a NG-RAN Node 120B with one or more cells, it is possible that the triggering event impacts only a subset of the cell(s). Amongst these cell(s), the requesting node 120A might be notified only if some data collection (for example, related to energy cost or UE performance) is in progress. In some examples, impact level is described quantitatively (for example, from 0 to 100), whilst in other examples impact level is described qualitatively (for example, Low/Med/High).
Impact Indicator: In some examples, when offloading action based reporting of the impact information is requested, an impact indicator indicates whether the impact level includes any ongoing offloading action. Any ongoing offloading action is likely to impact the performance metric further. Hence, if such an indication is received, the requesting node 120A can request a subsequent measurement of the performance to determine the total impact.
Duration: This indicates the duration of the impact 235. For example, for how long a target node 120B detects an impact. In some examples this may be a predicted or expected duration.

In summary, the reported impact 235 may comprise at least the impact level according to a determined measure or metric and, if applicable, the impacting node information and/or impact indicator and/or duration.

FIGS. 5 to 7 are signal diagrams which depict examples of the procedure of different impact calculation and reporting configurations (offloading action based, total additional load based, threshold based).

### Offloading Action Based (FIG. 5)

The signaling chart of FIG. 5 can comprise some or all of the features of the signaling charts of FIGS. 2, 3a, 3b and 4.

The first node 120A sends the request message 215 to the second node 120B. The first node 120A then initiates an offloading action to the second node 120B. The offloading action comprises a first handover 325-1, a last handover 325-n and may comprise further handovers between the first and last.

The third node 120C initiates a first offloading action to the second node 120B. The first offloading action comprises a first handover 345-1, a second handover 345-2, a last handover 345-m and may comprise further handovers between the first and last. In the illustrated example, the last handover 345-m comprises an indication that the first offloading action is complete.

At block 510, in response to receiving the indication that the first offloading action is complete, the second node 120B determines that the first offloading action from the third node 120C is complete.

At block 520, in response to this determination the second node 120B calculates the impact level for the first offloading action. In some examples, this is the number of handovers from the third node 120C divided by the number of handovers from the first node 120A.

The second node 120B then sends a message 525 comprising impact information. The impact information comprises the calculated impact level.

The third node 120C initiates a second offloading action to the second node 120B. The second offloading action comprises a first handover 545-1, a second handover 545-2, a last handover 545-k and may comprise further handovers. The last handover 545-k comprises an indication that the second offloading action is complete.

At block 530, in response to receiving the indication that the second offloading action is complete, the second node 120B determines that the offloading action from the third node 120C is complete.

At block 540, in response to this determination, the second node 120B calculates the impact level for the first offloading action.

The second node 120B then sends a message 545 comprising impact information. The impact information comprises the calculated impact level.

The first node 120A subsequently completes the last handover 325-n of its offloading action. In the illustrated example, the last handover 325 comprises an indication that the offloading action is complete.

In FIG. 5 the second NG-RAN node 120B identifies the end of the offloading action from the third RAN Node 120C through an explicit “offloading action complete indicator”. The second NG-RAN node 120B then assesses the impact level and sends a notification to the first NG-RAN node 120A. The second NG-RAN node 120B continues to notify the impact level for any subsequent offloading action from the third NG-RAN node 120C until the offloading action from the first NG-RAN node 120A completes.

### Total Additional Load Based (FIG. 6)

The signaling chart of FIG. 6 can comprise some or all of the features of the signaling charts of FIGS. 2, 3a, 3b, 4 and 5. The signaling chart of FIG. 6 is similar to the signaling chart of FIG. 5 with some differences.

At block 520, the second node 120B calculates the impact level for the first offloading action. In this example the second node 120B does not report the impact level substantially immediately after this.

At block 640, the second node 120B calculates the impact level for the second offloading action. The second node 120B also calculates the total impact level for both the first and second offloading actions from the third node 120C.

The first node 120A subsequently completes the last handover 325-n of its offloading action. The last handover 325 comprises an indication that the offloading action is complete.

In response to receiving this indication that the offloading action is complete from the first node 120A, the second node 120B sends a message 645 comprising impact information. The impact information comprises the calculated total impact level.

In FIG. 6, the second NG-RAN node 120B continues to evaluate the impact level of each offloading action that is triggered from one or more NG-RAN nodes. After the completion of the offloading action from the first NG-RAN node 120A, the second NG-RAN node 120B then sends the consolidated the impact level of all offloading actions together. This reduces signaling and thus interference and may also reduce computing resources used by the first node 120A. However, this delays reporting of the impact 235.

Impact Threshold based (FIG. 7)

The signaling chart of FIG. 7 can comprise some or all of the features of the signaling charts of FIGS. 2, 3a, 3b, 4, 5 and 6.

At block 710, the second node 120B calculates the impact level of the first handover 345-1 from the third node 120C.

At block 720, the second node 120B calculates the impact level of the second handover 345-1 from the third node 120C. The second node 120B also calculates the total impact level.

At block 730, the second node 120B calculates the impact level of the mth handover 345-1 from the third node 120C. The second node 120B also calculates the total impact level.

At block 740, the second node 120B determines that the total impact level has reached a threshold. In response, the second node 120B sends a message 745 comprising the impact information to the first node 120A. The impact information comprises the calculated total impact level. In the illustrated example, the message 745 also comprises the measurement information such as energy cost.

In FIG. 7, the second NG-RAN node 120B calculates the impact level per handover request and checks if the impact level reaches a preconfigured threshold. Notification to the first NG-RAN node 120A is triggered when the impact level reaches or exceeds the threshold. Until then, the cumulative impact level is calculated for the handover requests.

FIG. 8 depicts an example of an overall flow. The signaling chart of FIG. 8 can comprise some or all of the features of the signaling charts of FIGS. 2, 3a, 3b, 4, 5, 6 and 7.

1: The first NG-RAN node 120A sends a request message 215 to the second NG-RAN node 120B. This comprises configuration information for the measurement(s) of the second RAN Node 120B. The measurement may be measurements for AI/ML operations. Additionally, the request message 215 includes configuration information related to the event-based notification of the metric impact. In this example the metric is an energy cost metric. The first NG-RAN node 120A includes its meas ID in the message 215.

2: The second NG-RAN node 120B sends an acknowledgement 805 to the first NG-RAN node 120A, including its measurement ID in the message 805.

3: The first NG-RAN node 120A starts the offloading action by triggering handover procedures. This comprises sending the first handover request 325-1. The first handover request 325-1 comprises the corresponding measurement IDs (a pair of measurement IDs from the two NG-RAN nodes 120A, 120B).

4.1: At block 810, upon receipt of the first handover request 325-1, the second NG-RAN node 120B determines if it needs to collect information on the impact 235 of the requested energy cost metric by the offloadings of neighbouring NG-RAN nodes 120C. In some examples this may be based on an impact flag in the request message 215 being set to ‘true’). If this is the case then it proceeds to block 820.

4.2: At block 820, the second NG-RAN node 120B identifies the time instance it receives the first handover request 325-1 as the start of the offloading action from the first NG-RAN node 120A.

4.3: At block 830, the second NG-RAN node 120B begins monitoring other actions (for example, offloading actions from other NG-RAN nodes 120C) which could impact a requested metric of energy cost.

In some examples, the second NG-RAN node 120B sends a handover request acknowledgement to the first NG-RAN node 120A. Subsequent handover requests and responses continue.

5: An offloading action from the third NG-RAN node 120C starts with the first handover request 345-1. The second NG-RAN node 120B starts assessing the impact 235 to the requested performance metric (energy cost).

6: When the offloading action from the third NG-RAN node 120C completes with handover 345-m, if the reporting configuration is set to “immediate”, the second NG-RAN node 120B triggers an immediate notification to the first NG-RAN node 120A with the impact level and the impacting NG-RAN node information (the third NG-RAN node 120C). If the reporting configuration is set to “combined with node performance metric reporting”, the second NG-RAN node 120B does not trigger the reporting but continues monitoring and calculating the impact 235. Even in a case of “immediate” reporting configuration, the second NG-RAN node 120B may continue the monitoring and calculating further impact 235 after the immediate notification and send a further report of the further impact in 845, as described below.

7: The first NG-RAN node 120A sends a handover request 325-n corresponding to the last handover in the offloading.

8: At block 840, if the reporting trigger is based on offloading action when the second NG-RAN node 120B determines that the offloading has completed at other nodes (here the third NG-RAN node 120C) it will compute the per action impact for the energy cost metric.

9: At block 850, this computation takes place.

10: The second NG-RAN node 120B sends, for example, in the AI/ML information update message 845, the measured energy cost value. The message 845 may include information about the impact level and the nodes involved in this impact 235 (in the example the third NG-RAN node 120C). If the offloading from the third NG-RAN node 120C is completed this is indicated through an indicator that no other concurrent offloading actions are in progress.

FIG. 9 illustrates an example where multiple offloadings take place towards the second NG-RAN node 120B from a third NG-RAN node 120C and a fourth NG-RN node 120D. The signaling chart of FIG. 9 can comprise some or all of the features of the signaling charts of FIGS. 2, 3a, 3b, 4, 5, 6, 7 and 8. The signaling chart of FIG. 9 is similar to the signaling chart of FIG. 8 with some differences.

The fourth network node 120D sends two or more handover requests 445-1, 445-k to the second network node 120B.

In the example, even though the offloading from the third NG-RAN node 120C completes this is not the case for the fourth NG-RAN node 120D. In the reporting of energy cost from the second NG-RAN node 120B to the first NG-RAN node 120A, the second NG-RAN node 120B indicates that there is an ongoing offloading from the fourth NG-RAN node 120D.

FIG. 10 illustrates an example method 1000 according to examples of the disclosure. The method may be performed by the target network node 120B or an apparatus for the target network node 120B.

At block 1002, the apparatus receives a message 215 from a requesting network node 120A, the message 215 comprising a request for measurement information of a measurement on an energy cost of the target network node 120B, and the message 215 comprising a message field requesting impact information of an impact 235 of at least one other network node 120C, 120D on the measurement.

At block 1004, the apparatus acquires the measurement information. At block 1006, the apparatus acquires the impact information. At block 1008, the apparatus sends to the requesting network node 120A the measurement information and the impact information. At block 1010, the apparatus performs, based on the sent measurement information and the sent impact information, at least one action related to traffic offloading.

FIG. 11 illustrates an example method 1100 according to examples of the disclosure. The method may be performed by the requesting network node 120A or an apparatus for the requesting network node 120A.

At block 1102, the apparatus sends a message 215 to a target network node 120B, the message 215 comprising a request for measurement information of a measurement on an energy cost of the target network node 120B, and the message 215 comprising a message field requesting impact information of an impact 235 of at least one other network node 120C, 120D on the measurement.

At block 1104, the apparatus receives, from the target network node 120B, the measurement information and the impact information. At block 1106, the apparatus performs, based on the measurement information and the impact information, at least one action related to traffic offloading.

FIG. 12 illustrates an example of a controller 1200 suitable for use in an apparatus such as a network node 120. The apparatus may be an apparatus for the target network node 120B or an apparatus for the requesting network node 120A.

Implementation of a controller 1200 may be as controller circuitry. The controller 1200 may be implemented in hardware alone, have certain aspects in software including firmware alone or can be a combination of hardware and software (including firmware).

As illustrated in FIG. 12 the controller 1200 may be implemented using instructions that enable hardware functionality, for example, by using executable instructions of a computer program 1206 in a general-purpose or special-purpose processor 1202 that may be stored on a computer readable storage medium (disk, memory etc.) to be executed by such a processor 1202.

The processor 1202 is configured to read from and write to the memory 1204. The processor 1202 may also comprise an output interface via which data and/or commands are output by the processor 1202 and an input interface via which data and/or commands are input to the processor 1202.

The memory 1204 stores a computer program 1206 comprising computer program instructions (computer program code) that controls the operation of the apparatus when loaded into the processor 1202. The computer program instructions, of the computer program 1206, provide the logic and routines that enables the apparatus to perform the methods illustrated in the accompanying Figs. The processor 1202 by reading the memory 1204 is able to load and execute the computer program 1206.

The apparatus for the requesting network node 120A comprises:
at least one processor 1202; and
at least one memory 1204 including computer program code,
the at least one memory 1204 and the computer program code configured to, with the at least one processor 1202, cause the apparatus at least to perform:
sending, by a requesting network node 120A, a message 215 to a target network node 120B, the message 215 comprising a request for measurement information of a measurement on an energy cost of the target network node 120B, and the message 215 comprising a message field requesting impact information of an impact 235 of at least one other network node 120C on the measurement;
receiving, by the requesting network node 120A, from the target network node 120B the measurement information and the impact information; and
performing, by the requesting network node 120A and based on the measurement information and the impact information, at least one action related to traffic offloading

The apparatus for the target network node 120B comprises:
at least one processor 1202; and
at least one memory 1204 including computer program code,
the at least one memory 1204 and the computer program code configured to, with the at least one processor 1202, cause the apparatus at least to perform:
receiving, by a target network node 120B, a message 215 from a requesting network node 120A, the message 215 comprising a request for measurement information of a measurement on an energy cost of the target network node 120B, and the message 215 comprising a message field requesting impact information of an impact 235 of at least one other network node 120C on the measurement;
acquiring, by the target network node 120B, the measurement information;
acquiring, by the target network node 120B, the impact information;
sending, by the target network node 120B, to the requesting network node 120A the measurement information and the impact information; and performing, by the target network node 120B and based on the sent measurement information and the sent impact information, at least one action related to traffic offloading.

The apparatus for the requesting network node 120A comprises:
at least one processor 1202; and
at least one memory 1204 storing instructions that, when executed by the at least one processor 1202, cause the apparatus at least to:
sending, by a requesting network node 120A, a message 215 to a target network node 120B, the message 215 comprising a request for measurement information of a measurement on an energy cost of the target network node 120B, and the message 215 comprising a message field requesting impact information of an impact 235 of at least one other network node 120C on the measurement;
receiving, by the requesting network node 120A, from the target network node 120B the measurement information and the impact information; and
performing, by the requesting network node 120A and based on the measurement information and the impact information, at least one action related to traffic offloading

The apparatus for the target network node 120B comprises:
at least one processor 1202; and
at least one memory 1204 storing instructions that, when executed by the at least one processor 1202, cause the apparatus at least to:
receiving, by a target network node 120B, a message 215 from a requesting network node 120A, the message 215 comprising a request for measurement information of a measurement on an energy cost of the target network node 120B, and the message 215 comprising a message field requesting impact information of an impact 235 of at least one other network node 120C on the measurement;
acquiring, by the target network node 120B, the measurement information;
acquiring, by the target network node 120B, the impact information;
sending, by the target network node 120B, to the requesting network node 120A the measurement information and the impact information; and performing, by the target network node 120B and based on the sent measurement information and the sent impact information, at least one action related to traffic offloading.

As illustrated in FIG. 13, the computer program 1206 may arrive at the apparatus via any suitable delivery mechanism 1208. The delivery mechanism 1208 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1206. The delivery mechanism may be a signal configured to reliably transfer the computer program 1206. The apparatus may propagate or transmit the computer program 1206 as a computer data signal.

Computer program instructions for causing an apparatus to perform at least the following or for performing at least the following:
sending, by a requesting network node 120A, a message 215 to a target network node 120B, the message 215 comprising a request for measurement information of a measurement on an energy cost of the target network node 120B, and the message 215 comprising a message field requesting impact information of an impact 235 of at least one other network node 120C on the measurement;
receiving, by the requesting network node 120A, from the target network node 120B the measurement information and the impact information; and
performing, by the requesting network node 120A and based on the measurement information and the impact information, at least one action related to traffic offloading

Computer program instructions for causing an apparatus to perform at least the following or for performing at least the following:
receiving, by a target network node 120B, a message 215 from a requesting network node 120A, the message 215 comprising a request for measurement information of a measurement on an energy cost of the target network node 120B, and the message 215 comprising a message field requesting impact information of an impact 235 of at least one other network node 120C on the measurement;
acquiring, by the target network node 120B, the measurement information;
acquiring, by the target network node 120B, the impact information;
sending, by the target network node 120B, to the requesting network node 120A the measurement information and the impact information; and performing, by the target network node 120B and based on the sent measurement information and the sent impact information, at least one action related to traffic offloading.

The computer program instructions may be comprised in a computer program, a non-transitory computer readable medium, a computer program product, a machine readable medium. In some but not necessarily all examples, the computer program instructions may be distributed over more than one computer program.

Although the memory 1204 is illustrated as a single component/circuitry it may be implemented as one or more separate components/circuitry some or all of which may be integrated/removable and/or may provide permanent/semi-permanent/dynamic/cached storage.

Although the processor 1202 is illustrated as a single component/circuitry it may be implemented as one or more separate components/circuitry some or all of which may be integrated/removable. The processor 1202 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the accompanying FIGs may represent steps in a method and/or sections of code in the computer program 1206. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

In some but not necessarily all examples, the apparatus is configured to communicate data from the apparatus with or without local storage of the data in a memory 1204 at the apparatus and with or without local processing of the data by circuitry or processors at the apparatus.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long-range cellular radio links. The apparatus may comprise a communications interface such as, for example, a radio transceiver for communication of data.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

According to various, but not necessarily all, examples there is provided an apparatus for a network node, the apparatus comprising: means for sending a message to a target network node, the message comprising a request for measurement information of a measurement relating to the target network node, and the message comprising a message field requesting impact information of an impact of at least one other network node on the measurement; means for receiving from the target network node the measurement information and the impact information; and means for performing, based on the measurement information and the impact information, at least one action.

According to various, but not necessarily all, examples there is provided an apparatus for a network node, the apparatus comprising: means for receiving a message from a requesting network node, the message comprising a request for measurement information of a measurement relating to the network node, and the message comprising a message field requesting impact information of an impact of at least one other network node on the measurement; means for acquiring the measurement information; means for acquiring the impact information; means for sending to the requesting network node the measurement information and the impact information; and means for performing, based on the sent measurement information and the sent impact information, at least one action.

According to various, but not necessarily all, examples there is provided a method comprising: sending, by a requesting network node, a message to a target network node, the message comprising a request for measurement information of a measurement relating to the target network node, and the message comprising a message field requesting impact information of an impact of at least one other network node on the measurement; receiving, by the requesting network node, from the target network node the measurement information and the impact information; and performing, by the requesting network node and based on the measurement information and the impact information, at least one action.

According to various, but not necessarily all, examples there is provided a computer program comprising program instructions for causing a network node to perform at least the following: sending a message to a target network node, the message comprising a request for measurement information of a measurement relating to the target network node, and the message comprising a message field requesting impact information of an impact of at least one other network node on the measurement; receiving, from the target network node the measurement information and the impact information; and performing, based on the measurement information and the impact information, at least one action.

According to various, but not necessarily all, examples there is provided a method comprising: receiving, by a target network node, a message from a requesting network node, the message comprising a request for measurement information of a measurement relating to the target network node, and the message comprising a message field requesting impact information of an impact of at least one other network node on the measurement; acquiring, by the target network node, the measurement information; acquiring, by the target network node, the impact information; sending, by the target network node, to the requesting network node the measurement information and the impact information; and performing, by the target network node and based on the sent measurement information and the sent impact information, at least one action.

According to various, but not necessarily all, examples there is provided a computer program comprising program instructions for causing a network node to perform at least the following: receiving a message from a requesting network node, the message comprising a request for measurement information of a measurement relating to the target network node, and the message comprising a message field requesting impact information of an impact of at least one other network node on the measurement; acquiring the measurement information; acquiring the impact information; sending to the requesting network node the measurement information and the impact information; and performing, and based on the sent measurement information and the sent impact information, at least one action.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus for a network node comprising:
at least one processor; and
at least one memory including computer program code,
the at least one memory and the computer program code configured to, with the at least one processor, cause the apparatus at least to perform:
sending a message to a target network node, the message comprising a request for measurement information of a measurement on an energy cost of the target network node, and the message comprising a message field requesting impact information of an impact of at least one other network node on the measurement;
receiving from the target network node the measurement information and the impact information; and
performing, based on the measurement information and the impact information, at least one action related to traffic offloading.

2. The apparatus of claim 1, wherein the network node is a node in a radio access network; and wherein the measurement on the energy cost relates to at least one handover from the network node to the target network node.

3. The apparatus of claim 1, wherein the impact is the impact on the measurement of at least one traffic offloading action between the target network node and the at least one other network node.

4. The apparatus of claim 1, wherein the impact information comprises an impact level, wherein the impact level is the energy cost due to the impact of the at least one other network node on the measurement.

5. The apparatus of claim 4, wherein the impact information comprises an impact indicator which indicates whether the impact level includes any impact from ongoing offloading traffic.

6. The apparatus of claim 1, wherein the impact information comprises a duration of the impact.

7. The apparatus of claim 1, wherein the message further comprises configuration information, wherein the configuration information is for configuring sending the measurement information and the impact information from the target network node.

8. The apparatus of claim 7, wherein the configuration information comprises instructions to send the impact information in response to: an offloading action between the target network node and at least one other network node; the impact level exceeding a threshold; and/or a ratio of the impact level to the energy cost exceeding a threshold.

9. The apparatus of claim 7, wherein the configuration information comprises instructions to send the impact information substantially immediately after the impact information is acquired and/or to send the impact information concurrent with the measurement information.

10. The apparatus of claim 7, wherein the apparatus is further configured to send a further message to the target network node, the further message comprising an indication that the offloading traffic is complete; and wherein the configuration information comprises instructions to send the impact information in response to the target network node receiving the indication that the offloading traffic is complete.

11. An apparatus for a network node comprising:
at least one processor; and
at least one memory including computer program code,
the at least one memory and the computer program code configured to, with the at least one processor, cause the apparatus at least to perform:
receiving a message from a requesting network node, the message comprising a request for measurement information of a measurement on an energy cost of the network node, and the message comprising a message field requesting impact information of an impact of at least one other network node on the measurement;
acquiring the measurement information;
acquiring the impact information;
sending to the requesting network node the measurement information and the impact information; and
performing, based on the sent measurement information and the sent impact information, at least one action related to traffic offloading.

12. A method comprising:
sending, by a requesting network node, a message to a target network node, the message comprising a request for measurement information of a measurement on an energy cost of the target network node, and the message comprising a message field requesting impact information of an impact of at least one other network node on the measurement;
receiving, by the requesting network node, from the target network node the measurement information and the impact information; and
performing, by the requesting network node and based on the measurement information and the impact information, at least one action related to traffic offloading.

13. The apparatus of claim 12, wherein the requesting network node is a node in a radio access network; and wherein the measurement on the energy cost relates to at least one handover from the network node to the target network node.

14. The apparatus of claim 12, wherein the impact is the impact on the measurement of at least one traffic offloading action between the target network node and the at least one other network node.

15. The apparatus of claim 12, wherein the impact information comprises an impact level, wherein the impact level is the energy cost due to the impact of the at least one other network node on the measurement.

16. The apparatus of claim 15, wherein the impact information comprises an impact indicator which indicates whether the impact level includes any impact from ongoing offloading traffic.

17. The apparatus of claim 12, wherein the message further comprises configuration information, wherein the configuration information is for configuring sending the measurement information and the impact information from the target network node.

18. The apparatus of claim 17, wherein the configuration information comprises instructions to send the impact information in response to: an offloading action between the target network node and at least one other network node; the impact level exceeding a threshold; and/or a ratio of the impact level to the energy cost exceeding a threshold.

19. The apparatus of claim 18, wherein the configuration information comprises instructions to send the impact information substantially immediately after the impact information is acquired and/or to send the impact information concurrent with the measurement information.

20. The apparatus of claim 19, wherein the apparatus is further configured to send a further message to the target network node, the further message comprising an indication that the offloading traffic is complete; and wherein the configuration information comprises instructions to send the impact information in response to the target network node receiving the indication that the offloading traffic is complete.
